(19) United States
(12) Patent Application Publication
(10) Pub. No.: US 2024/0409349 A1
(43) Pub. Date: Dec. 12, 2024

(54) WINDING CORE HOLDING DEVICE AND AUTOMATED GUIDED VEHICLE

(71) Applicant: Murata Manufacturing Co., Ltd., Nagaokakyo-shi (JP)

(72) Inventors: Hiroaki MAKINO, Nagaokakyo-shi (JP); Atsushi OONO, Nagaokakyo-shi (JP)

(21) Appl. No.: 18/735,421

(22) Filed: Jun. 6, 2024

(30) Foreign Application Priority Data
Jun. 7, 2023 (JP) 2023-094346

(51) Int. Cl. B65H 19/30; B65H 27/00

(52) U.S. Cl. CPC B65H 19/30; B65H 27/00; B65H 2401/11; B65H 2401/15; B65H 2402/42; B65H 2404/152; B65H 2405/40

(57) ABSTRACT

A winding core holder includes a holder main body, a lifter to raise and lower the holder main body, and a roller movably held relative to the holder main body, enabling the winding core to be placed and moved in the winding core axial direction. The roller includes a high-release surface with a higher release property than a surface of the holder main body.

### CROSS REFERENCE TO RELATED APPLICATIONS

This application claims the benefit of priority to Japanese Patent Application No. 2023-094346 filed on Jun. 7, 2023. The entire contents of this application are hereby incorporated herein by reference.

### BACKGROUND OF THE INVENTION

### 1. Field of the Invention

The present invention relates to winding core holding devices and automated guided vehicles.

### 2. Description of the Related Art

Conventionally, an automated guided vehicle is known, which serves as a winding core holding device that holds a winding core with an adhesive surface. For instance, Japanese Unexamined Patent Application, Publication No. 2004-91007 discloses an automated guided vehicle that supplies a winding core to a sheet winding device and retrieves a roll from the sheet winding device.

In the cases where the winding core surface includes an adhesive such as adhesive tape, after the sheet winding device chucks the winding core, when the winding core holder of the delivery device is lowered, the adhesive on the winding core surface may stick to the winding core holder, potentially resulting in the adhesive being peeled off the winding core.

### SUMMARY OF THE INVENTION

Example embodiments of the present invention provide winding core holding devices and automated guided vehicles, each able to prevent an adhesive from peeling off a winding core, for example, when the winding core is supplied to a sheet winding device.

A winding core holding device according to an example embodiment of the present invention includes a winding core holder to hold a winding core with an adhesive surface, in which the winding core holder includes a holder main body, a lifter to raise and lower the holder main body, and a roller movably held relative to the holder main body to enable the winding core to be placed and moved in a winding core axial direction, and the roller includes a high-release surface that is higher in a release property than a surface of the holder main body.

An automated guided vehicle according to an example embodiment of the present invention includes a winding core holder to hold a winding core with an adhesive surface, in which the winding core holder includes a holder main body, a lifter to raise and lower the holder main body, and a roller movably held relative to the holder main body to enable the winding core to be placed and moved in a winding core axial direction, and the roller includes a high-release surface that is higher in a release property than a surface of the holder main body.

Example embodiments of the present invention provide winding core holding devices and automated guided vehicles, each able to prevent the adhesive from peeling off a winding core, for example, when the winding core is supplied to a sheet winding device.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating a manufacturing system that includes an automated guided vehicle according to an example embodiment of the present invention.

FIG. 2 is a schematic view of a winding device of an example embodiment of the present invention, as viewed from the front (downstream side in the delivery direction).

FIG. 3 is a birds-eye view of a holder main body of a winding core holder according to an example embodiment of the present invention.

FIG. 4 is a schematic view of the winding core holder, as viewed from the front of the automated guided vehicle.

FIG. 5 is a schematic diagram illustrating the lifting operation of the winding core holder.

FIG. 6 is a schematic diagram illustrating the lifting operation of the roll holder.

FIG. 7 is a block diagram illustrating the hardware configuration of an automated guided vehicle according to an example embodiment of the present invention.

FIG. 8 is a block diagram illustrating the functional configuration of an automated guided vehicle control device according to an example embodiment of the present invention.

FIG. 9 is a block diagram illustrating the hardware configuration of a ceramic green sheet molding device according to an example embodiment of the present invention.

FIG. 10 is a block diagram illustrating the functional configuration of a control device according to an example embodiment of the present invention.

FIG. 11 is a flowchart illustrating the flow of roll manufacturing steps according to an example embodiment of the present invention.

FIG. 12 is a flowchart illustrating the flow of the roll winding step included in the roll manufacturing steps illustrated in FIG. 11.

FIG. 13 is a flowchart illustrating the flow of the roll removing step and the winding core setting steps when consecutively performing the roll winding step of FIG. 12.

FIG. 14 is a schematic diagram illustrating the first half of the roll retrieval operation included in the winding core setting step of FIG. 13.

FIG. 15 is a schematic diagram illustrating the second half of the roll retrieval operation included in the winding core setting step of FIG. 13.

FIG. 16 is a schematic diagram illustrating the first half of the winding core setting operation included in the winding core setting step of FIG. 13.

FIG. 17 is a schematic diagram illustrating the latter half of the winding core setting operation included in the winding core setting step of FIG. 13.

### DETAILED DESCRIPTION OF THE EXAMPLE EMBODIMENTS

Example embodiments of the present invention will be described in detail below with reference to the accompanying drawings.

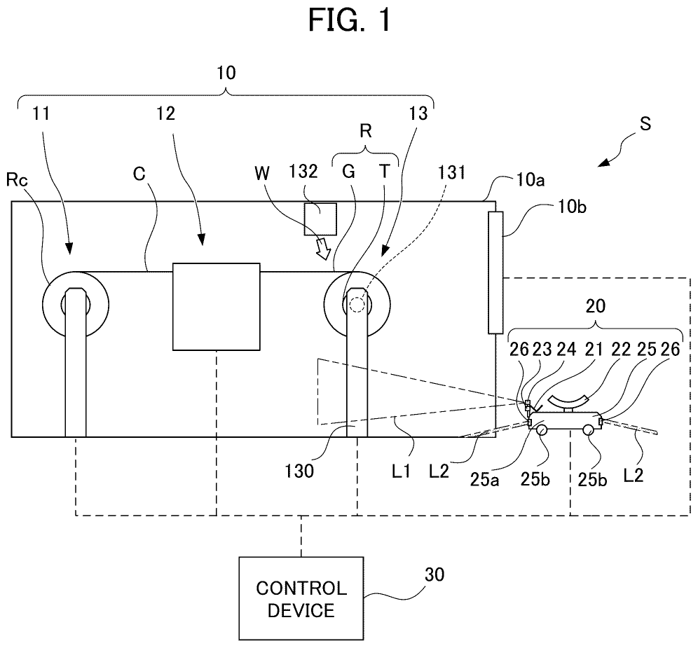

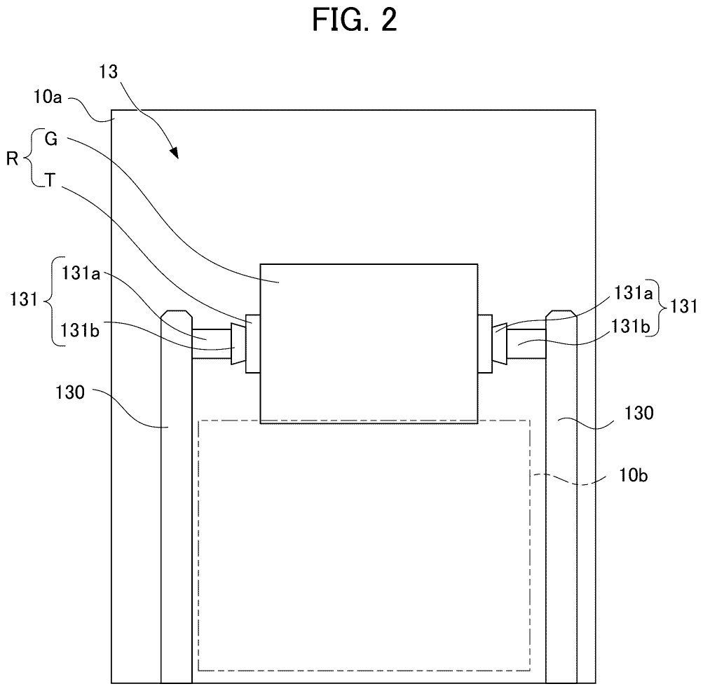

Hereinafter, a manufacturing system S, which includes an automated guided vehicle as a winding core holding device according to an example embodiment of the present invention, will be described with reference to FIGS. 1 and 2. FIG. 1 is a schematic diagram illustrating the manufacturing system S including the automated guided vehicle according to an example embodiment of the present invention. FIG. 2 is a schematic diagram of a winding device of the present example embodiment, as viewed from the front (downstream side in the delivery direction).

The manufacturing system S is designed to produce and deliver rolls R of a green sheet film G to subsequent processes. The green sheet film G is an intermediate product in the process of manufacturing multilayer ceramic electronic components. Examples of multilayer ceramic electronic components may include multilayer ceramic capacitors.

The manufacturing system S is not limited to handling the green sheet film G but can be applied to manufacturing systems that involves winding a sheet onto a winding core T to produce a roll R.

As illustrated in FIG. 1, the manufacturing system S includes a ceramic green sheet molding device 10, an automated guided vehicle 20, and a control device 30. The manufacturing system S includes, as the control device, an automated guided vehicle control device 27 described later of the automated guided vehicle 20, and the control device 30. Details are described below.

### Ceramic Green Sheet Molding Device

The ceramic green sheet molding device 10 will be described using FIGS. 1 and 2. In the present example embodiment, the ceramic green sheet molding device 10 molds a ceramic green sheet on a carrier film C. In the following description, the carrier film C with the ceramic green sheet molded thereon is collectively referred to as the green sheet film G. The ceramic green sheet molding device 10 winds the green sheet film G as a sheet onto the winding core T to produce the roll R. That is, the roll R includes the green sheet film G as a sheet wound onto the winding core T.

Here, the winding core T is used to wind the green sheet film G. The winding core T is a cylindrical member including a hollow portion, into which a winding shaft described later is inserted. The winding core T includes an adhesive on the surface. Therefore, when winding the green sheet film G onto the winding core T, one end of the green sheet film G can easily be adhered to the winding core T. In the present example embodiment, the winding core T is, for example, a paper tube made of paper. However, the material of the winding core T is not limited to this, and may be made of, for example, plastic or metal.

As illustrated in FIG. 1, the ceramic green sheet molding device 10 includes an unwinding device 11, a coater 12, and a winding device 13 defines and functions as a sheet winding device. The ceramic green sheet molding device 10 may include a housing 10a. The housing 10a covers the unwinding device 11, the coater 12, and the winding device 13, and is capable of protecting the molded green sheet film G from external environment such as external temperature variation and dust. The housing 10a includes an opening, through which the automated guided vehicle 20 delivering the manufactured rolls R can enter and exit, and the opening includes a shutter 10b as described later.

As illustrated in FIG. 1, the unwinding device 11 unwinds the carrier film C from the upper side of the roll Rc towards the coater 12, and supplies the carrier film C to the coater 12. The carrier film C may be, for example, a translucent plastic film.

In the present example embodiment of the manufacturing system S, the unwinding device 11 unwinds the carrier film C from the upper side of the roll Rc loaded with the carrier film C. However, this is not limited. For instance, the unwinding device 11 may alternatively unwind the carrier film C from the lower side of the roll Rc loaded with the carrier film C. In the present example embodiment of the manufacturing system S, the rotational axis of the roll Rc in the unwinding device 11 is set to rotate in conjunction with the winding device 13 described later. However, the setting of the rotational axis of the roll Rc in the unwinding device 11 is not limited thereto.

The coater 12 applies a slurry including a ceramic material onto the carrier film C, and molds the ceramic green sheet on the carrier film C. In the present example embodiment, the slurry including a ceramic material is applied onto the carrier film C using, for example, a doctor blade method. The green sheet film G, which includes the ceramic green sheet molded on the carrier film C by the coater 12, is dried in a drying section (not illustrated) and then delivered to the winding device 13.

As illustrated in FIG. 1, the winding device 13 winds the green sheet film G molded on the carrier film C from the upper side of the winding core T into a roll, thus manufacturing and retrieving the roll R. The winding device 13 includes a pair of supports 130 and a pair of chucking devices 131. In the present example embodiment of the manufacturing system S, the winding device 13 winds the green sheet film G from the upper side of the winding core T into a roll. However, this is not limited. For example, the winding device 13 may wind the green sheet film G from the lower side of the winding core T into a roll.

As illustrated in FIGS. 1 and 2, the supports 130 are designed to support the chucking devices 131. The supports 130 are provided to extend upwards from the floor. However, the configuration of the supports 130 is not limited to this. For instance, anything that supports the chucking devices 131 may used, or the supports may horizontally extend from the frame.

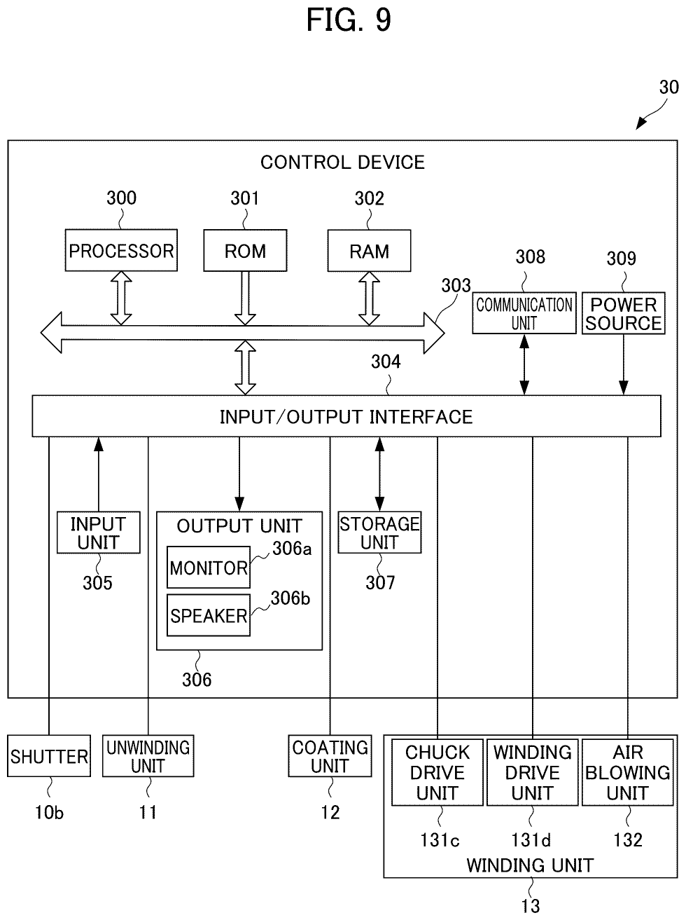

The chucking devices 131 are designed to rotatably hold the winding core T. For example, the chucking devices 131 according to the present example embodiment include a pair of winding shafts 131a as well as a pair of chucks 131b as illustrated in FIG. 2, a chuck drive 131c as illustrated in FIG. 9 described later, and a winding drive 131d.

The pair of winding shafts 131a are designed to chuck and rotate the winding core T. In the present example embodiment, the first one of the pair of winding shafts 131a is held by the support 130 so as to be slidable in the direction of the pair of support units 130 facing each other, and is driven by the chuck drive 131c to slide in the direction of the pair of winding shafts 131a facing each other. Not limited to this, both of the pair of winding shafts 131a may be held to be slidable in the direction of facing each other, and is driven by the chuck drive 131c to slide in the direction of the pair of winding shafts 131a facing each other.

The chuck drive 131c may use, for example, an air cylinder or motor as a drive source. The second one of the pair of winding shafts 131a is fixed to the support 130. Thus, the first one of the pair of winding shafts 131a is driven by the chuck drive 131c to slide so as to narrow the distance between the pair of winding shafts 131a, thus allowing the pair of winding shafts 131a to move to the chucking position to chuck the winding core T. The first one of the pair of winding shafts 131a is driven by the chuck drive 131c to slide so as to widen the distance between the pair of winding shafts 131a, thus allowing the pair of winding shafts 131a to move to the chuck releasing position to release the winding core T from chucking.

The pair of chucks 131b are designed to hold the winding core T. The chuck 131b are, for example, frustoconical members with the diameter decreasing towards one end in the central axis direction and increasing towards the other end. More specifically, one side of the chuck 131b in the central axis direction is smaller than the hollow portion of the winding core T. The other side of the chuck 131b in the central axis direction is larger than the hollow portion of the winding core T. The shape of the chuck 131b is not limited to this.

The other side of the chuck 131b is set at one end of the winding shaft 131a. Therefore, the one side of the chuck 131b can be inserted into the hollow portion of the winding core T, and the peripheral surface of the chuck 131b can be pressed against and fitted to the inner surface of the hollow portion. That is, the pair of chuck 131b are pushed from both sides by the pair of winding shafts 131a and can fit into the hollow portion of the winding core T, thereby allowing for chucking the winding core T.

The first one of the pair of chuck 131b is rotatably held at one end of the first one of the pair of winding shafts 131a. The second one of the pair of chuck 131b is rotatably held at one end of the second one of the pair of winding shafts 131a, and rotates when driven by the winding drive 131d. The winding drive 131d may use a motor as the drive source, for example. In the present example embodiment, the winding drive 131d is provided only on the side of the second one of the pair of chuck 131b, which is not limited, and may be provided on both sides.

Thus, in the state where the winding core T is positioned between the pair of winding shafts 131a, such that the central axis of the winding shafts 131a substantially aligns with the central axis of the winding core T, the chucking device 131 moves the pair of winding shafts 131a to the chucking position, thus allowing for chucking the winding core T. While the winding core T is chucked, the chuck 131 rotates the second one of the pair of chucks units 131b when driven by the winding drive unit 131d, thereby allowing for the winding operation.

Therefore, in the winding device 13, the winding core T set in the chucking device 131 is rotationally driven by the winding drive 131d, thus winding the green sheet film G molded on the carrier film C around the winding core T to form the roll R.

The winding device 13 of the manufacturing system S may include an air blower 132. For example, in the present example embodiment of the manufacturing system S, the air blower 132 is provided in the upper area near the winding device 13 within the housing 10a.

In the present example embodiment, the air blower 132 is provided in the upper area near the winding device 13 within the housing 10a, which is not limited. For instance, the air blower 132 may be provided on the automated guided vehicle 20.

As illustrated in FIG. 1, when a translucent film is hanging from the roll set in the winding device 13, the air blower 132 blows air W such that the hanging translucent film will flutter. For example, the air blower 132 may directly blow air onto the translucent film hanging from the roll R, or may blow air through another member.

The air blower 132 can blow air onto the green sheet film G hanging, efficiently causing the translucent film to flutter. This improves the efficiency for the detection unit to detect the translucent film.

As illustrated in FIGS. 1 and 2, the winding device 13 of the manufacturing system S may include a shutter 10b that blocks the entry of the automated guided vehicle 20. An example of the shutter 10b may include, for example, a door, rails that support the door to vertically slide, and a shutter drive unit that causes the door to vertically slide. The shutter 10b includes an opened state in which the door is slid up to the top to allow the entry of the automated guided vehicle, and a closed state in which the door is slid down to the bottom to block the entry of the automated guided vehicle 20.

### Automated Guided Vehicle

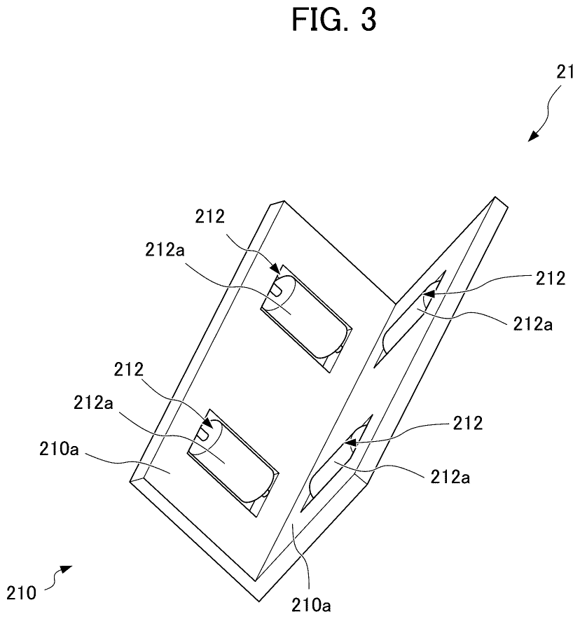

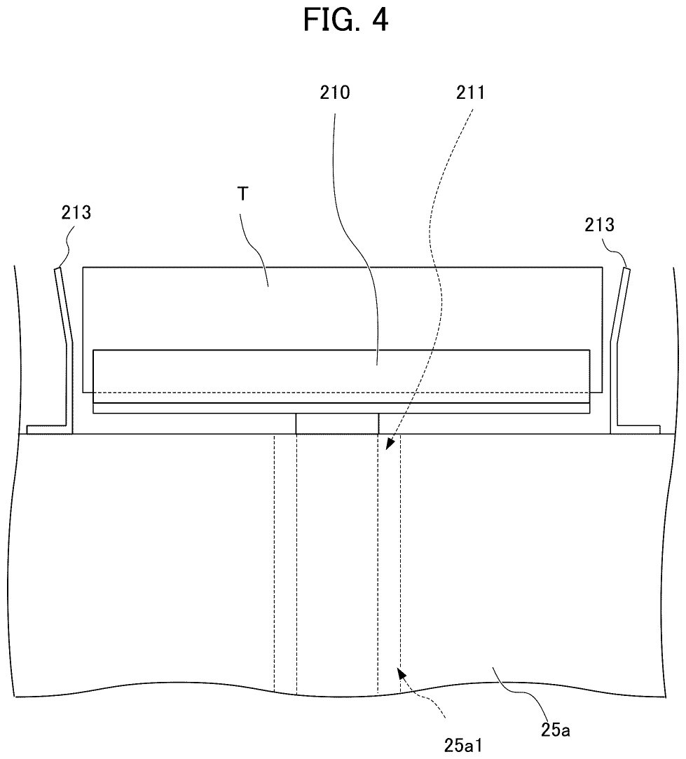

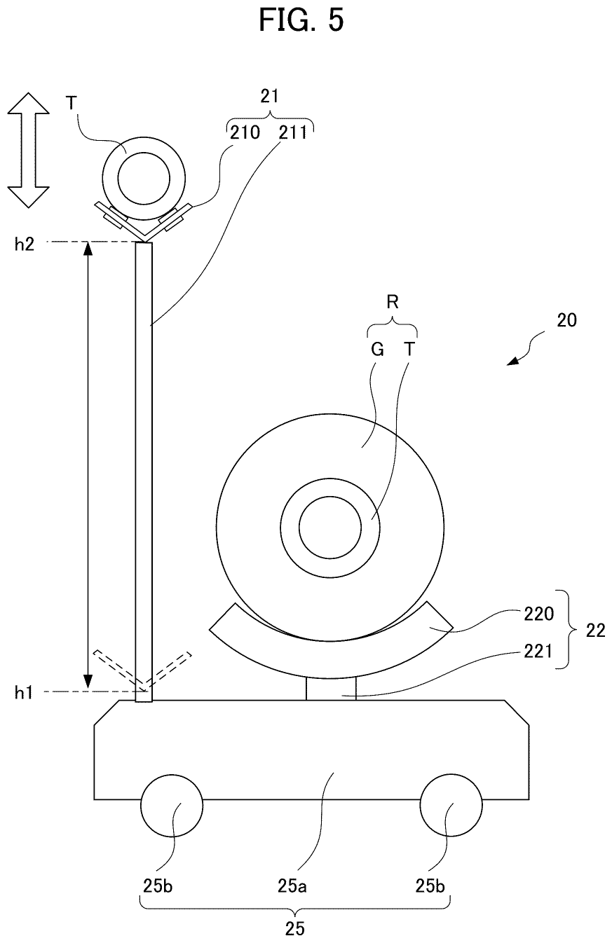

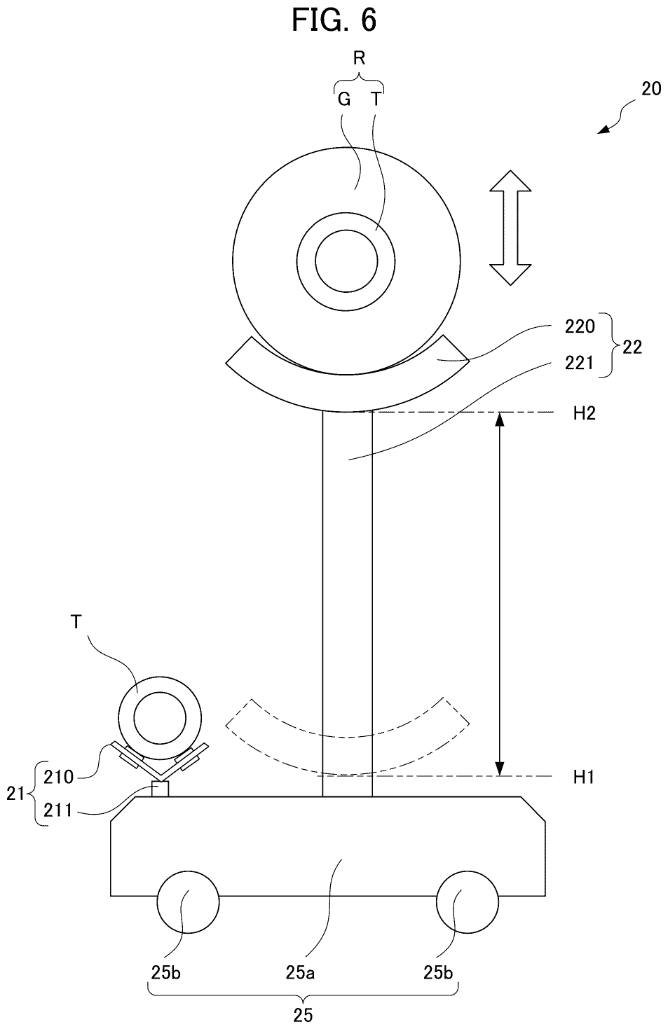

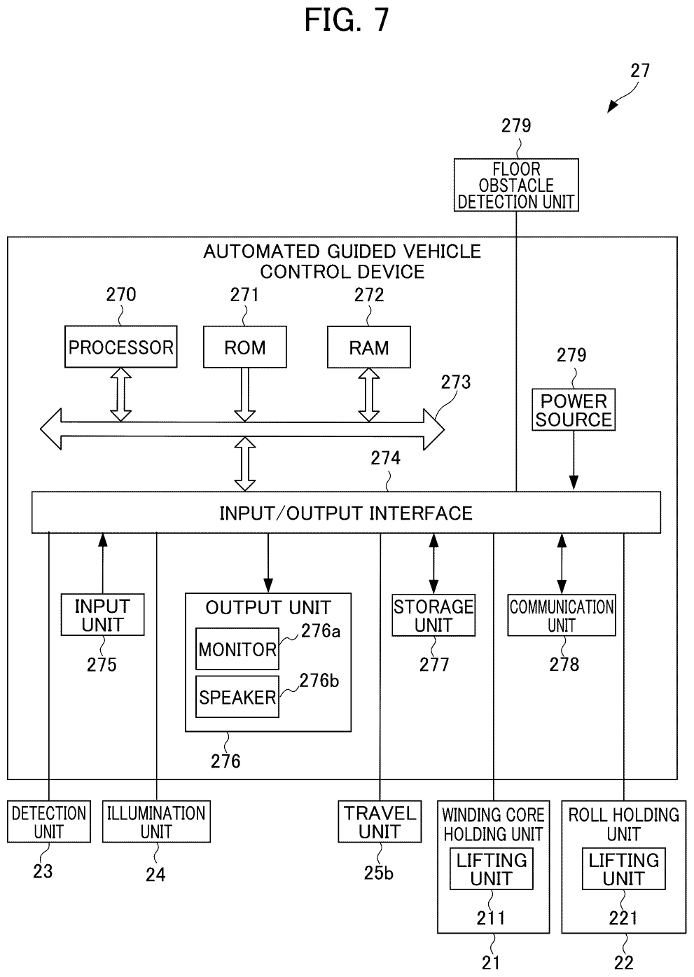

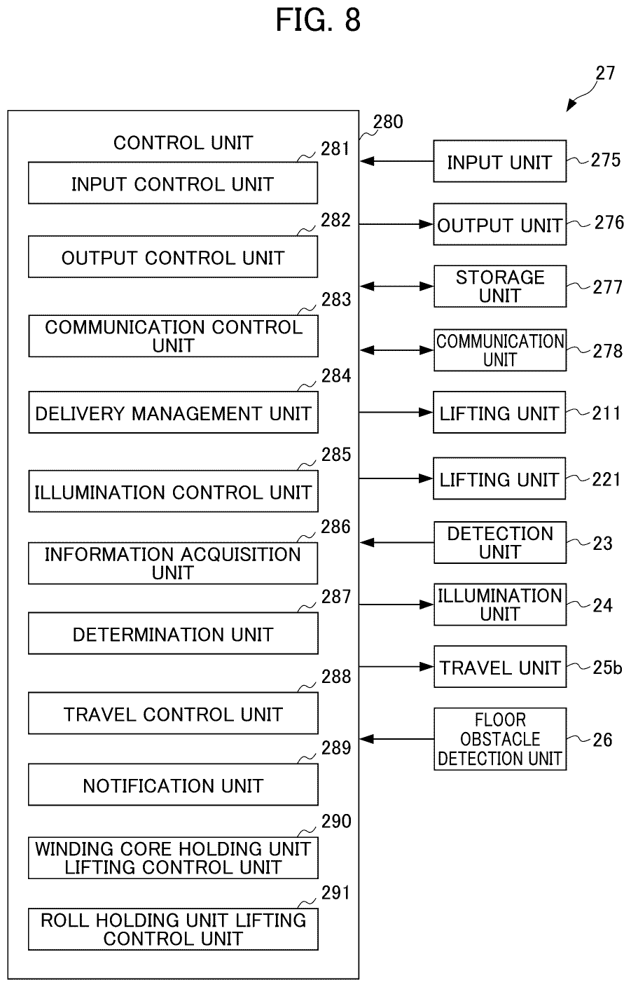

Next, the automated guided vehicle 20 is described using FIGS. 1 and 3 to 8. FIG. 3 is a birds-eye view of a holder main body 210 of a winding core holder 21 according to the present example embodiment. FIG. 4 is a schematic diagram of the winding core holder 21 of the automated guided vehicle 20, as viewed from the front. For simplicity in description, illustration of a roller 212 described later is omitted in FIG. 4. FIG. 5 is a schematic diagram illustrating the lifting operation of the winding core holder 21. FIG. 6 is a schematic diagram illustrating the lifting operation of a roll holder 22. FIG. 7 is a block diagram illustrating the hardware configuration of the automated guided vehicle 20 according to the present example embodiment. FIG. 8 is a block diagram illustrating the functional configuration of an automated guided vehicle control device 27 according to the present example embodiment.

The automated guided vehicle 20 supplies the winding core T to the winding device 13 defining and functioning as a sheet winding device, and retrieves the roll R from the winding device 13. More specifically, the automated guided vehicle 20 delivers and supplies the winding core T to the chucking device 131 of the winding device 13. The automated guided vehicle 20 also retrieves the roll R, which has been manufactured from the green sheet film G wound around the winding core T, from the winding device 13, and delivers the retrieved roll R to a designated location.

The automated guided vehicle 20 according to the present example embodiment, for example, travels along pre-laid rails along a predetermined route defined as the travel route of the automated guided vehicle 20. The automated guided vehicle 20 may store travel route information in a storage 277 described later, acquire the own position information, and travel along the predetermined route based on the travel route information and the acquired position information.

As illustrated in FIGS. 1, and 3 to 8, the automated guided vehicle 20 includes a winding core holder 21 that holds the winding core T, a roll holder 22 that holds the roll, a stopper 213 defining and functioning as a movement restrictor to restrict movement of the winding core in the winding core axial direction, a detector 23, an illuminator 24, a vehicle body 25, a floor obstacle detector 26, and the automated guided vehicle control device 27 as illustrated in FIG. 7. For convenience of description, illustration of the stopper 213 is omitted, except for FIG. 4.

### Winding Core Holder

As illustrated in FIGS. 3, and 5 to 8, the winding core holder 21 includes a lifter 211, a holder main body 210, and a roller 212.

### Lifter

As illustrated in FIGS. 4, and 5 to 8, the lifter 211 is designed to raise and lower the holder main body 210. For example, the lifter 211 of the present example embodiment includes a hydraulic mechanism (not illustrated) and a winding core lifter that can be raised and lowered by the hydraulic mechanism. The winding core lifter is telescopically provided within a hollow portion 25al of a trolley 25a, which will be described later, of the vehicle body 25. The winding core lifter may include a known telescopic mechanism such as, for example, telescopic pipes or a multi-joint link mechanism, and the winding core lifter is designed to extend during raising and to contract during lowering. That is, the winding core lifter is raised or lowered when extended or retracted by the hydraulic mechanism. The drive source for the lifting mechanism is not limited to the hydraulic mechanism. An example of the drive source may be an electric motor.

### Holder Main Body

The holder main body 210 is a member to hold the winding core T. The holder main body 210 includes two surfaces that face the winding core T when the winding core T is placed on the roller 212. For example, as illustrated in FIG. 3, the holder main body 210 includes two inclined surfaces 210a that form a V-shape on the surfaces. In other words, the two surfaces 210a are inclined so as to diverge upwards.

The holder main body 210 may be, for example, made of stainless steel. However, the material of the holder main body 210 is not limited to stainless steel. The holder main body 210 is preferably made from a material with rigidity, and is preferably made from metal. In this case, the surface of the holder main body 210 is metallic. The surface of the holder main body 210 may include rubber such as, for example, a urethane rubber sheet, placed over the surface made of metal such as stainless steel.

The holder main body 210 can be raised and lowered. For example, the holder main body 210 is held by the winding core lifter of the lifter 211, and raised or lowered when driven by the lifter 211. The lifter 211 position-controls the holder main body 210 between a lowered position h1 and a raised position h2. For instance, the lowered position h1 is the position of the holder main body 210 as illustrated in FIG. 5. The raised position h2 is the position of the holder main body 210 as illustrated in FIG. 5. The holder main body 210 may include detectors, such as, for example, proximity sensors or touch sensors, to detect whether the winding core T is held.

### Roller

The roller 212 is designed to place the winding core T so as to be movable in the winding core axial direction. The roller 212 is held to be rollable in relation to the holder main body 210. The roller 212 is axially supported in a direction intersecting the winding core axial direction. Therefore, the roller 212 can place the winding core T so as to be movable in the axial direction of the winding core T. The surface 212a of the roller 212 includes a high-release surface that is higher in a release property than the surface 210a of the holder main body 210.

At least the surface 212a of the roller 212 may be made of a material including, for example, fluorine resin. For example, the roller 212 may be made of fluorine resin. Alternatively, for example, electroless nickel plating including fluorine resin may be provided on the surface 212a of the roller 212. Alternatively, fluorine resin may be coated on the surface 212a of the roller 212. The surface 212a of the roller 212 may be subjected to a release surface treatment. For instance, the surface 212a of the roller 212 may be a release surface with a texture created by sandblasting or similar methods to reduce the contact area with the winding core T.

The winding core holder 21 includes at least four rollers 212. For example, the winding core holder 21 includes at least two rollers 212 on each of the two inclined surfaces of the holder main body 210. Although the present example embodiment uses cylindrical rollers as the rollers, the roller is not limited to cylindrical rollers. For example, spherical ball rollers may be used.

### Stopper

The automated guided vehicle 20 further includes a stopper 213 defining and functioning as a movement restrictor. When the holder main body 210 of the winding core holder 21 is in the lowered position h1, the stopper 213 restricts movement of the winding core T in the winding core axial direction held by the holder main body 210 of the winding core holder 21. When the holder main body 210 of the winding core holder 21 is in the raised position h2, the stopper 213 exposes the ends of the winding core T held by the holder main body 210 of the winding core holder 21.

As illustrated in FIG. 4, the stopper 213 includes a pair of plate-shaped members provided on both ends of the holder main body 210 on the vehicle body 25 in the winding core axial direction. That is, the stopper 213 is provided as fixed on the vehicle body 25. Therefore, as illustrated in FIG. 4, when the holder main body 210 is in the lowered position h1, the plate-shaped members defining and functioning as the shield of the stopper 213 shield the ends of the winding core T placed on the roller 212, thus restricting movement of the winding core T in the winding core axial direction. When the holder main body 210 is in the raised position h2, the plate-shaped members defining and functioning as the shield expose the ends of the winding core T on the roller 212, thus releasing the restriction of movement of the winding core T in the winding core axial direction.

The pair of plate-shaped members are structured so as to diverge upwards. As a result, the entry to set the winding core T is widened, making it easier to set the winding core T into the holder main body 210. When setting the winding core T, the position of the winding core T in the winding core axial direction is guided to be properly positioned within the holder main body 210. Once the winding core T is set in the holder main body 210, movement of the winding core T is restricted in the winding core axial direction.

### Roll Holder

The roll holder 22 retrieves and holds the roll R, which is the green sheet film G wound into a roll by the winding device 13 of the ceramic green sheet molding device 10. As illustrated in FIGS. 5 to 8, the roll holder 22 includes a roll lifter 221 and a holder main body 220.

### Roll Lifter

The roll lifter 221 is designed to raise and lower the holder main body 220. For example, the roll lifter 221 of the present example embodiment includes a hydraulic mechanism (not illustrated) and a roll lifter that can be raised and lowered by the hydraulic mechanism. The roll lifter, similar to the winding core lifter, is provided within a hollow portion in the trolley 25a of the vehicle body 25 and is raised and lowered by the hydraulic mechanism. The drive source for the lifting mechanism is not limited to the hydraulic mechanism. An example of the drive source may be an electric motor.

### Holder Main Body of Roll Holder

The surface of the holder main body 220 that holds the roll R is a curved surface that fits the size of the roll R to be retrieved. This curved surface is preferably slightly larger in curvature radius than the roll R to be retrieved. However, the surface of the holder main body 220 that holds the roll R is not limited to a curved surface. For example, the surface may include two inclined surfaces.

The holder main body 220 is, for example, made of stainless steel. However, the material of the holder main body 220 is not limited to stainless steel. The holder main body 220 is preferably made of a material with rigidity, and is preferably made of metal. The surface of the holder main body 220 may include rubber such as, for example, a urethane rubber sheet, placed over the surface made of metal such as stainless steel. In other words, the surface of the holder main body 220 may be made of rubber. This prevents direct contact between the roll and the metal surface, thus protecting the roll. The rubber layer also helps distribute pressure and absorb shocks when holding the roll.

The holder main body 220 can be raised and lowered. The roll lifter 221 position-controls the holder main body 220 between the lowered position H1 and the raised position H2. For instance, the lowered position H1 is the position of the holder main body 220 as illustrated in FIG. 6. The raised position H2 is the position of the holder main body 220 as illustrated in FIG. 6. The holder main body 220 may also include detection means such as proximity sensors or touch sensors to detect whether the roll R is held.

### Detector to Detect Floor Obstacles

As illustrated in FIGS. 1, 7, and 8, the automated guided vehicle 20 may include a floor obstacle detector 26 to detect the presence or absence of obstacles on the floor surface, over which the automated guided vehicle 20 travels. For convenience of description, illustrations of the floor obstacle detector 26 may be omitted in this specification. The floor obstacle detector 26 may be provided in one and the other directions along the travel direction of the automated guided vehicle 20. For example, the floor obstacle detector 26 may be provided at the front and the rear of the automated guided vehicle 20 in the travel direction.

The floor obstacle detector 26 may be, for example, a non-contact sensor, such as an image sensor, laser scanner, ultrasonic sensor, or other types of sensors. For example, when using a laser scanner, as illustrated in FIG. 1, the reflected light of the laser light L2 being scanned and emitted is detected to identify the horizontal direction and detect obstacles on the floor.

### Detector

The detector 23 acquires information on the roll holder passage region. In the present example embodiment, the detector 23 is a hanging sheet detector that detects the presence of a sheet hanging from the roll R. When winding the roll R, the end of the roll R may hang after completing the winding of the roll R. Therefore, if a sheet is hanging from the roll R when the automated guided vehicle 20 enters the winding device 13 defining and functioning as the sheet winding device, the automated guided vehicle 20 may contact the hanging sheet, potentially causing issues such as damage to the roll.

More specifically, if the automated guided vehicle 20 enters the winding device 13 while the film is hanging from the roll R set in the winding device 13, the sheet hanging from the roll R may come into contact with the holder main body 220 or the roll lifter 221 of the roll holder 22 of the automated guided vehicle 20, potentially causing damage to the roll R.

If the automated guided vehicle 20 enters the winding device 13 while the film is hanging from the roll R set in the winding device 13, the sheet hanging from the roll R may get entangled in the wheels of the travel unit 25b of the automated guided vehicle 20, potentially causing damage to the roll R.

If the automated guided vehicle 20 including the winding core holder 21 enters the winding device 13 while the film is hanging from the roll R set in the winding device 13, the winding core T held by the winding core holder 21 of the automated guided vehicle 20 may stick to the sheet hanging from the roll R, potentially causing damage to the roll R.

Therefore, the automated guided vehicle 20 of the present example embodiment includes the detector 23 that detects the presence of a sheet hanging from the roll R set in the winding device 13. The automated guided vehicle control device 27, defining and functioning as the controller to be described later, controls the automated guided vehicle 20 to avoid contact with the hanging sheets if present.

Typically, molding of the green sheet film G onto the carrier film C excludes the beginning and the end of the roll R. Therefore, the beginning and the end of the roll R solely include the carrier film C, without the green sheet film G molded. In the present example embodiment, the carrier film C is defined by a translucent film. Thus, the sheet hanging from the roll R is the translucent film.

The detector 23 acquires information on the roll holder passage region, including the positions through which the roll holder 22 passes when the automated guided vehicle 20 travels. This enables the detector 23 to ensure that there are no obstacles along the path through which the roll holder 22 will pass.

In the present example embodiment, the detector 23 acquires information on the winding core passage region, including the positions through which the winding core T held by the winding core holder 21 passes when the automated guided vehicle 20 travels. This enables the detector 23 to ensure that there are no obstacles along the path through which the winding core holder 21 will pass.

The detector 23 of the present example embodiment is an image sensor that acquires image information of at least either the roll holder passage region or the winding core passage region. In the present example embodiment, the detector 23 acquires information on the roll holder passage region. The detector 23 acquires information on the winding core passage region.

The detector 23 of the present example embodiment acquires image information on the roll holder passage region and the winding core passage region at a plurality of timings, corresponding to a plurality of timings of emitting illumination light L1 from the illumination unit 24 described later.

The detector 23, which acquires information on at least either the roll holder passage region or the winding core passage region, does not necessarily need to detect the presence or absence of obstacles on the floor surface near the automated guided vehicle 20. The detector 23 preferably acquires information on a detection area above the detection area of the floor obstacle detector 26 described above.

The detector preferably acquires information from an area broader than the detection area of the floor obstacle detection unit 26. More specifically, the detector preferably acquires information from an area that is vertically broader than the detection area of the floor obstacle detector. The detector 23 defining and functioning as the hanging sheet detector can detect the presence of a sheet hanging from the roll R, even if the sheet does not reach the floor.

### Illuminator

The illuminator 24 is designed to improve the detection efficiency of the detector 23. The illuminator 24 emits the illumination light L1 towards the roll holder passage region, including the positions through which the roll holder 22 passes when the automated guided vehicle 20 travels. The illuminator 24 emits the illumination light L1 towards the winding core passage region, including the positions through which the winding core T held by the winding core holder 21 passes when the automated guided vehicle 20 travels.

The illuminator 24 may be integrated with the detection unit 23. In the present example embodiment, the illuminator 24 emits flash light defining and functioning as the illumination light L1. In the present example embodiment, the illuminator 24 is controlled to emit a plurality of flashes of illumination light L1 at time intervals. For example, the illuminator 24 intermittently illuminates at intervals of one second or less during the period since the shutter 10b opens until the automated guided vehicle 20 reaches the roll retrieval position.

### Vehicle Body

The vehicle body 25 includes the trolley 25a and the traveler 25b. The trolley 25a mounts various components of the automated guided vehicle 20. For example, the trolley 25a mounts the winding core holder 21, the roll holder 22, the detector 23, the illuminator 24, and the floor obstacle detector 26 for detecting obstacles on the floor. The traveler 25b is designed to movably support the trolley 25a. The traveler 25b includes, for example, a plurality of wheels rotatably attached to the trolley 25a, and a driver that drives the wheels to rotate. The configuration of the traveler 25b is not limited to this.

### Automated Guided Vehicle Control Device

Next, an example of the automated guided vehicle control device 27 is described using FIG. 7. The automated guided vehicle control device 27 is designed to control various operations of the automated guided vehicle 20, such as roll retrieval operation, winding core setting operation, travel operation, and hanging film detection processing. The automated guided vehicle control device 27 includes a processor and other components, and the processor executes computational processing to control various operations. As illustrated in FIG. 7, the automated guided vehicle control device 27 includes a processor 270, ROM 271, RAM 272, a bus 273, an input/output interface 274, an input 275, an output 276, a storage 277, a communicator 278, and a power supply 279. The configuration of the automated guided vehicle control device 27 is not limited to this.

The processor 270, for example, executes various processing such as computation and control, which are necessary for operating the automated guided vehicle control device 27. The processor 270 may be, for example, a CPU (Central Processing Unit), MPU (Micro Processing Unit), SoC (System on Chip), DSP (Digital Signal Processor), GPU (Graphics Processing Unit), ASIC (Application Specific Integrated Circuit), PLD (Programmable Logic Device), FPGA (Field-Programmable Gate Array), or a combination of these. The processor 270 may also be combined with hardware accelerators.

The processor 270 controls various units of the automated guided vehicle control device 27 to provide the functions, based on firmware, system software, and application software programs stored in the ROM 271 or the RAM 272. The processor 270 executes the processing described below based on these programs. A portion or all of the programs may be embedded in the circuitry of the processor 270.

The processor 270, the ROM 271, and the RAM 272 are interconnected via a bus 273. The bus 273 is also connected to the input/output interface 274. The input 275, the output 276, the storage 277, the communicator 278, and the power supply 279 are connected to the input/output interface 274.

The input 275 and the output 276 are user interfaces electrically connected in a wired or wireless manner to an input/output interface (not illustrated). The input 275 includes, for example, operation buttons on the automated guided vehicle 20. The output 276 includes devices such as a monitor 276a that displays images for the operation of the automated guided vehicle 20, and a speaker 276b that amplifies sounds such as warnings. The input 275 and the output 276 may be integrated into a single unit including both display and input functionalities, such as a touchscreen.

The storage 277 includes primary storage devices including, for example, non-volatile memory such as ROM (Read Only Memory) or volatile memory such as RAM (Random Access Memory), and secondary storage devices including magnetic disks, optical disks, magneto-optical disks, or semiconductor memory. In the present example embodiment, the storage 277 stores delivery route information for the automated guided vehicle 20, audio data for outputting from the speaker 276b of the output 276, and various programs for execution by the controller 280.

The communicator 278 is a device that communicates wirelessly with other computers or devices using communication standards such as, for example, BLE (Bluetooth Low Energy) or Wi-Fi (Wireless Fidelity). However, communication is not limited to wireless communication. For instance, the communicator 278 may also perform wired communication with other computers or devices via a network cable.

The power supply 279 is a battery that supplies power to the automated guided vehicle 20. The power supply unit 279 may be a commonly used battery such as, for example, a lithium-ion secondary battery or may be a primary battery such as a dry-cell battery. The power supply 279 is not limited to batteries, and may also be connected to an external power source via a power cable to supply power to the automated guided vehicle 20.

### Control Block

Next, the functional configuration of the automated guided vehicle control device 27 is described using FIG. 8. The controller 280, which performs various controls for the automated guided vehicle 20, is defined by a processor executing a program for computational processing. The controller 280 of the present example embodiment includes an input controller 281, an output controller 282, a communication controller 283, a delivery management device 284, an illumination controller 285, an information acquirer 286, a determinator 287, a travel controller 288, a notifier 289, a winding core holder lifting controller 290, and a roll holder lifting controller 291.

The input controller 281 executes processing of the inputs on the input 275 by administrators or similar personnel of the automated guided vehicle 20. For example, the input controller 281 executes processing of the operation to turn on the power of the automated guided vehicle 20 performed by administrators or similar personnel.

The output controller 282 executes processing of displaying images on the monitor 276a of the output 276. For example, the output controller 282 executes processing of the operations to output the operation menu screen for operating the automated guided vehicle 20 on the monitor 276a.

The communication controller 283 executes processing of communication with external devices through the communicator 278. For example, the communication controller 283 executes processing of receiving delivery instruction information for the rolls R and the winding cores T as transmitted from the control device 30 through the communicator 278.

The delivery management device 284 executes processing of the operation to manage delivery of the rolls R and other items by the automated guided vehicle 20.

The illumination controller 285 controls the drive of the illuminator 24. For instance, the illumination controller 285 controls the illuminator 24 to emit a plurality of flashes of the illumination light L1 while the shutter 10b of the ceramic green sheet molding device 10 is open.

The information acquirer 286 acquires information acquired by the detector 23. The information acquirer 286 may acquire information detected by the floor obstacle detector 26.

The determinator 287 determines the presence or absence of a translucent film hanging from the roll R set in the winding device 13, based on the information acquired by the information acquirer 286. For example, the determinator 287 in the controller 280 determines the presence or absence of a translucent film sheet hanging from the roll R set in the winding device 13, based on information of at least either the roll holder passage region or the winding core passage region as acquired by the detector 23.

In the present example embodiment, the determinator 287 determines the presence or absence of a translucent film sheet hanging from the roll R, based on information of the roll holder passage region as acquired by the detector 23. The determinator 287 determines the presence or absence of a translucent film sheet hanging from the roll R, based on information of the winding core passage region as acquired by the detector 23.

The travel controller 288 executes roll delivery control, roll retrieval preparation control, winding core setting preparation control, and hanging film detection processing.

The roll delivery control involves controlling the traveler 25b to travel along a predefined route. For example, rails may be laid along the predefined route, and the automated guided vehicle 20 may travel along the rails.

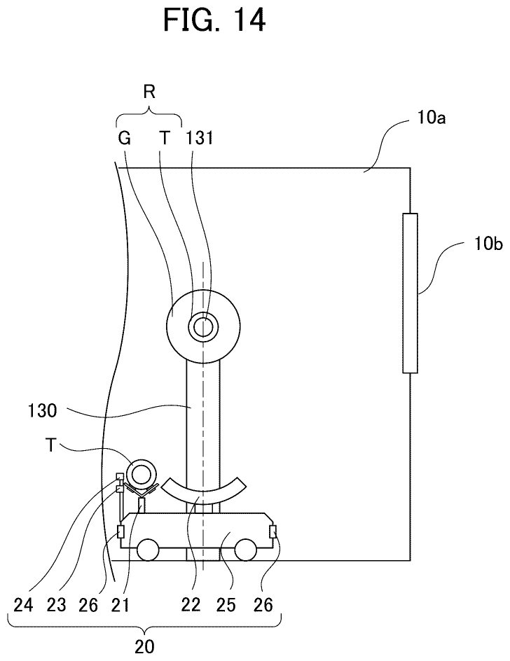

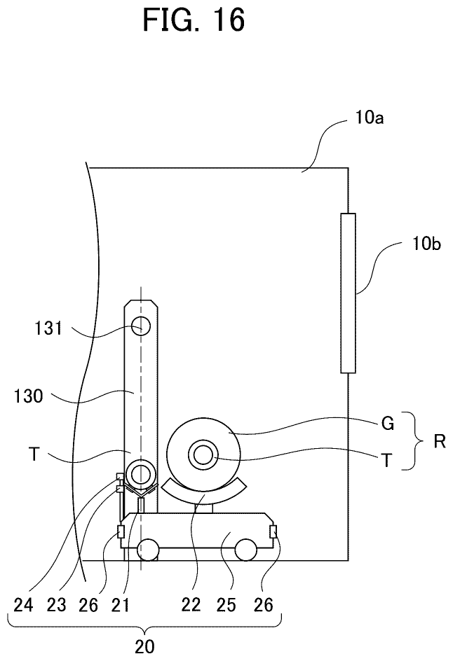

As illustrated in FIG. 14, the roll retrieval preparation control involves controlling the traveler 25b to move the holder main body 220 of the roll holder 22 to a roll retrieval position below the winding shaft 131a. As illustrated in FIG. 16, the winding core setting preparation control involves controlling the traveler 25b to move the holder main body 210 of the winding core holder 21 to a winding core setting position below the winding shaft 131a. Sensors may be provided at predefined intervals on the rails, allowing the controller 280 to find out the position of the automated guided vehicle 20.

During the hanging film detection processing, when determining that there is a translucent film hanging from the roll R set in the winding device 13, the travel controller 288 controls the automated guided vehicle 20 to stop. For example, the traveler 25b of the automated guided vehicle 20 is controlled to stop driving.

In the case of determining that there is a translucent film sheet hanging from the roll set in the winding device 13, the notifier 289 issues a notification. For instance, in the case of determining that there is a sheet hanging from the roll R set in the winding device 13, the notifier 289 causes the speaker 276b of the output 276 to beep.

The winding core holder lifting controller 290 controls the operation of the lifter 211 of the winding core holder 21. For example, as coordinated under the winding core setting preparation control by the travel controller 288, at the timing when the holder main body 210 of the winding core holder 21 has moved to a winding core setting position below the winding shaft 131a, the holder main body 210 of the winding core holder 21 is raised to the raised position h2.

The roll holder lifting controller 291 controls the operation of the roll lifter 221 of the roll holder 22. For example, as coordinated under the roll retrieval preparation control by the travel controller 288, at the timing when the holder main body 220 of the roll holder 22 has moved to a roll retrieval position below the winding shaft 131a, the holder main body 220 of the roll holder 22 is raised to the raised position H2.

### Control Device

Next, an example of the control device 30 is described using FIG. 9. FIG. 9 is a block diagram illustrating the hardware configuration of the ceramic green sheet molding device according to the present example embodiment. Detailed descriptions of components that are common or similar to those already discussed may be omitted and referred to by the same names.

The control device 30 is designed to control various operations for manufacturing the rolls R of the green sheet film G in the manufacturing system S and delivering the rolls R to subsequent processes. The control device 30 includes a processor and other components, and the processor executes computational processing through the processor to control various operations. As illustrated in FIG. 9, the control device 30 includes a processor 300, ROM 301, RAM 302, a bus 303, an input/output interface 304, an input 305, an output 306, a storage 307, a communicator 308, and a power supply 309. The configuration of the control device 30 is not limited to this.

### Control Block

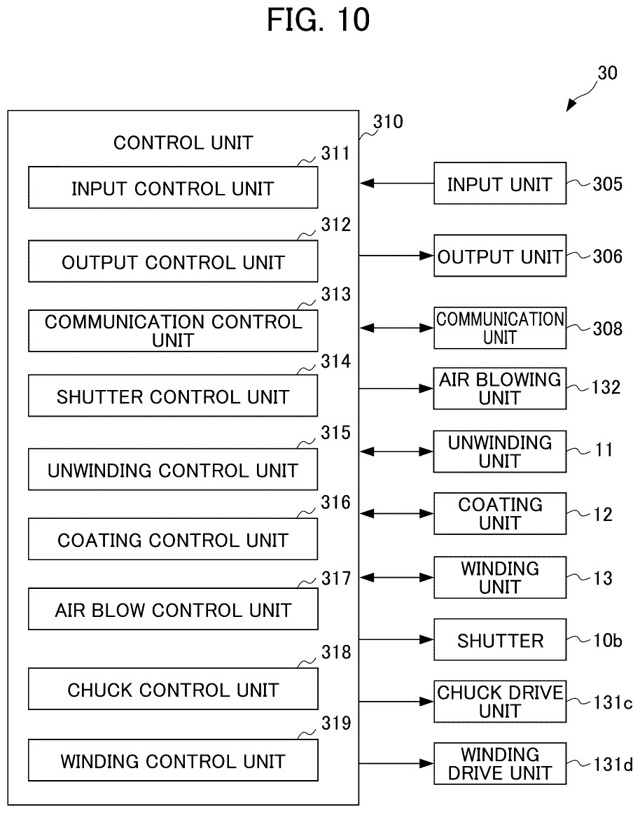

Next, the functional configuration of the control device 30 is described using FIG. 10. FIG. 10 is a block diagram illustrating the functional configuration of the control device according to the present example embodiment. Detailed descriptions of components that are common or similar to those already discussed may be omitted and referred to by the same names. The controller 310, which performs various controls for the manufacturing system S, is implemented by executing computational processing on a processor running programs. The controller 310 in the present example embodiment is configured or programmed to include an input controller 311, an output controller 312, a communication controller 313, a shutter controller 314, an unwinding controller 315, a coating controller 316, an air blow controller 317, a chuck controller 318, and a winding controller 319.

The shutter controller 314 controls the opening and closing of the shutter 10b of the ceramic green sheet molding device 10. For example, the shutter controller 314 executes processing to raise or lower the shutter 10b to move between an open position where the shutter 10b is open and a closed position where the shutter 10b is closed. The shutter controller 314 may open the shutter 10b at the timing when the automated guided vehicle 20 has got in proximity to the shutter 10b. The proximity of the automated guided vehicle 20 to the shutter 10b can be detected using known methods. The proximity of the automated guided vehicle 20 may be detected using, for example, sensors such as proximity sensors.

Alternatively, the shutter controller 314 may open the shutter 10b at the timing of receiving a command to open the shutter 10b from the automated guided vehicle 20. In this case, at the timing of getting in proximity to the shutter 10b, the automated guided vehicle 20 may send a command to open the shutter 10b to the control device 30.

The unwinding controller 315 executes various controls for the unwinding device 11. For example, the unwinding controller 315 controls the unwinding device 11 to chuck the roll Rc of the carrier film C. The control by the unwinding controller 315 for chucking the roll Rc is similar to the control by the chuck controller 318 for chucking the roll R, thus the description thereof is omitted.

The coating controller 316 performs various controls for the coater 12. For instance, the coating controller 316 controls the coater 12 to apply a slurry including a ceramic material onto the carrier film C, and controls the drying section (not illustrated) to perform drying operation.

The air blow controller 317 controls the air blower 132 to perform air blow operation. For example, during the winding operation by the winding device 13 to wind the green sheet film G molded on the carrier film C into a roll, the air blow controller 317 controls the air blower 132 to perform air blow operation. The control of the air blow operation is not limited to this.

The chuck controller 318 controls the chucking device 131 to perform chucking operation. For example, the chuck controller 318 controls the chucking operation when the winding core T is not chucked by the chucking device 131. In this case, the chuck controller 318 verifies whether the holder main body 210, which holds the winding core T, of the winding core holder 21 of the automated guided vehicle 20 has moved to the raised position h2. The chuck controller 318 starts the chucking operation to move the pair of winding shafts 131a to the chucking position where the winding core T is chucked at the timing when the holder main body 210 has moved to the raised position h2.

The chuck controller 318 controls the chucking operation in the state where the chucking device 131 has chucked the wound roll R. In this case, the chuck controller 318 verifies whether the holder main body 220 of the roll holder 22 of the automated guided vehicle 20 has moved to the raised position H2. The chuck controller 318 starts the chucking operation to move the pair of winding shafts 131a to the chuck releasing position where the roll R is chucked at the timing when the holder main body 220 has moved to the raised position H2.

Known techniques can be used as a method for detecting whether the holder main body 210 of the winding core holder 21 of the automated guided vehicle 20 has moved to the raised position h2, or whether the holder main body 220 of the roll holder 22 has moved to the raised position H2. For example, photoelectric sensors may be provided on each of the pair of supports 130. In this case, blocking the light between the photoelectric sensors may lead to determination that the holder main body 210 of the winding core holder 21 has moved to the raised position h2, or that the holder main body 220 of the roll holder 22 has moved to the raised position H2.

The winding controller 319 executes various controls for the winding device 13. For example, the winding controller 319 controls the winding device 13 to perform winding operation for winding the green sheet film G molded on the carrier film C into a roll. The winding operation as controlled by the winding controller 319 is coordinated with the control of the unwinding operation by the unwinding controller 315 and the control of the coating and drying operations by the coating controller 316.

### Roll Manufacturing Steps

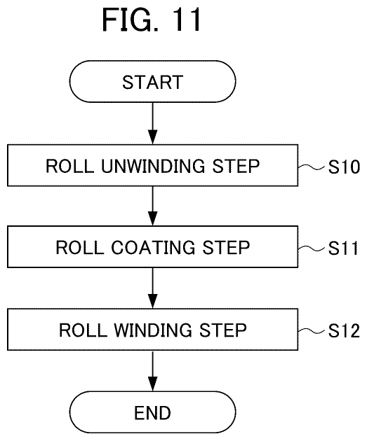

Next, the roll manufacturing steps executed by a manufacturing system S according to an example of the present invention are described using FIG. 11. FIG. 11 is a flowchart illustrating the flow of the roll manufacturing steps according to the present example embodiment. The roll manufacturing steps include a roll unwinding step (Step S10), a roll coating step (Step S11), and a roll winding step (Step S12).

The roll unwinding step (Step S10) is the step of unwinding the roll of the carrier film C and supplying the carrier film C to the coater.

The roll coating step (Step S11) is the step of applying a slurry including a ceramic material onto the carrier film C and molding a ceramic green sheet on the carrier film C. In the roll coating step (Step S11), the ceramic green sheet molded on the carrier film C may be dried.

The roll winding step (Step S12) is the step of winding the green sheet film G into a roll and retrieving the roll.

### Roll Winding Step

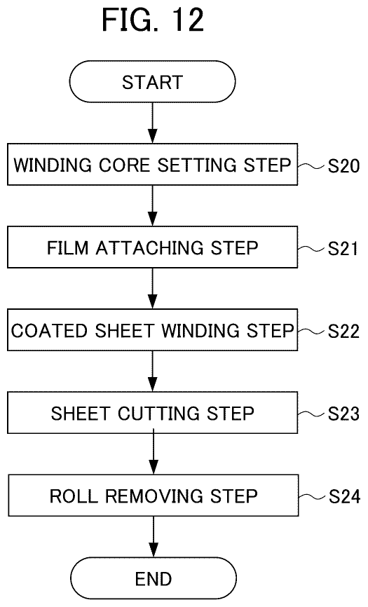

Next, the roll winding step of winding the green sheet film G onto the winding core T set in the winding device 13 to form the roll R is described using FIG. 12. FIG. 12 is a flowchart illustrating the flow of the roll winding step included in the roll manufacturing steps described in FIG. 11. The roll winding step (Step S12) executed by the manufacturing system S includes the winding core setting step (Step S20), the film attaching step (Step S21), the coated sheet winding step (Step S22), the sheet cutting step (Step S23), and the roll removing step (Step S24).

In the present example embodiment, when the roll winding step (Step S12) is executed consecutively, the roll removing step (Step S24) of the previous roll winding step (Step S12) and the winding core setting step (Step S20) of the subsequent roll winding step (Step S12) are executed consecutively. Details will be described later.

The winding core setting step (Step S20) is the step of setting the winding core T on the winding shaft 131a. Details will be described later.

The film attaching step (Step S21) is the step of attaching the end face of the carrier film C to the winding core T set on the winding shaft 131a. The film may be attached manually or by a machine designed to attach the film.

The coated sheet winding step (Step S22) is the step of winding the coated sheet onto the winding core T set on the winding shaft 131a. For example, the winding controller 319 controls the winding drive unit 131d to rotate the winding shaft 131a, and to wind the coated sheet onto the winding core T set on the winding shaft 131a.

The sheet cutting step (Step S23) is the step of cutting the sheet of the carrier film C to complete the roll. Since one end of the carrier film C is adhered to the winding core of the roll Rc, once a certain amount of the carrier film C is wound to form the roll R, the roll R is connected to the roll Rc via the carrier film C. Therefore, the sheet is cut in order to detach the sheet of the carrier film C from the winding core of the roll Rc. The sheet may be cut manually or by a machine designed to cut the sheet.

The roll removing step (Step S24) is the step of removing the roll R from the winding shaft 131a. Details will be described later.

After completing the removal of the roll R, the control device 30 opens the shutter 10b, and the automated guided vehicle 20 delivers the roll R along a designated route to a warehouse or similar location. Subsequently, the control device 30 controls the shutter 10b to be closed. The winding device 13 may include an auto reel change function.

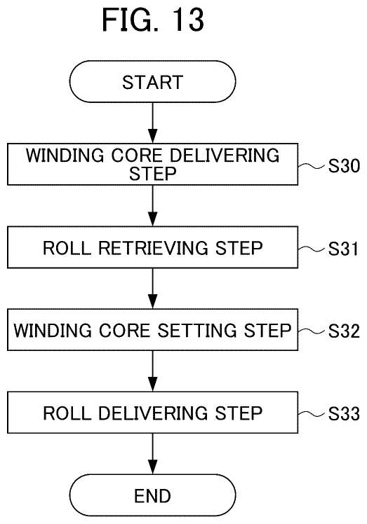

Next, when the roll winding step (Step S12) is executed consecutively, the roll removing step (Step S24) of the previous roll winding step (Step S12) and the winding core setting step (Step S20) of the subsequent roll winding step (Step S12) are executed consecutively, which will be described in detail using FIGS. 13 to 17.

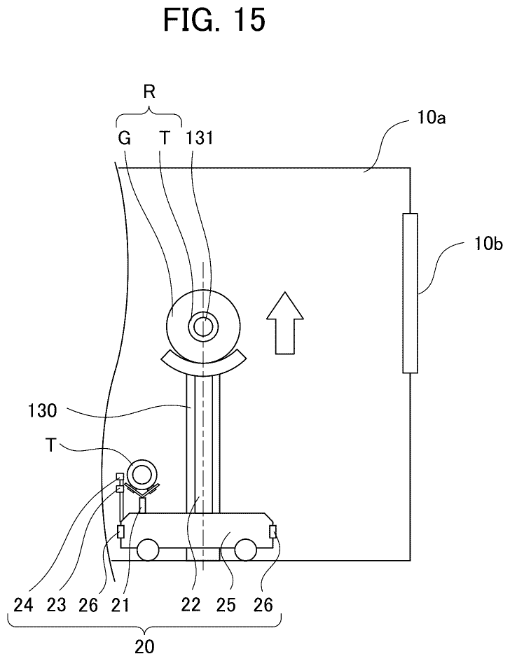

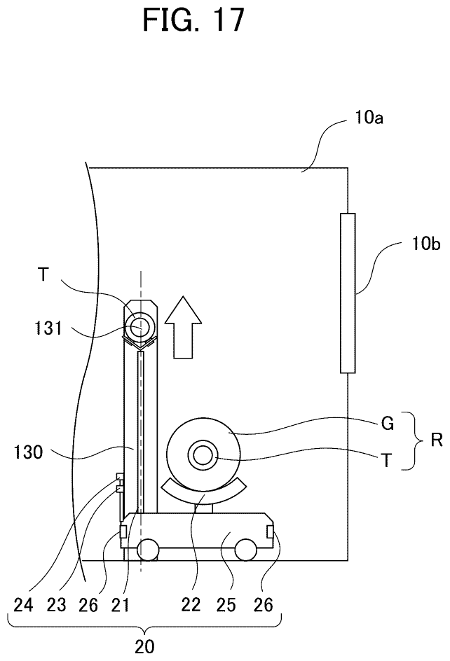

FIG. 13 is a flowchart illustrating the flow of the roll removing step and the winding core setting step when the roll winding step in FIG. 12 is executed consecutively. FIG. 14 is a schematic diagram illustrating the first half of the roll retrieving operation included in the winding core setting step of FIG. 13. FIG. 15 is a schematic diagram illustrating the second half of the roll retrieving operation included in the winding core setting step of FIG. 13. FIG. 16 is a schematic diagram illustrating the first half of the winding core setting operation included in the winding core setting step of FIG. 13. FIG. 17 is a schematic diagram illustrating the second half of the winding core setting operation included in the winding core setting step of FIG. 13.

The roll removing step (Step S24) and the winding core setting step (Step S20), when executed consecutively, include the winding core delivering step (Step S30), the roll retrieving step (Step S31), the winding core setting step (Step S32), and the roll delivering step (Step S33).

In the winding core delivering step (Step S30), the automated guided vehicle 20 moves to the winding device 13 while delivering the winding core T. For instance, when the automated guided vehicle 20 receives a call command transmitted from the control device 30, the travel controller 288 controls the travel unit 25b to move along a predetermined route to the front of the shutter 10b of the ceramic green sheet molding device 10.

First, the shutter controller 314, for example, opens the shutter 10b of the ceramic green sheet molding device 10. Specifically, the control device 30 uses a proximity sensor (not illustrated) to determine whether the automated guided vehicle 20 is in proximity, and when determining that the automated guided vehicle 20 is in proximity, the control device 30 controls the shutter 10b to move to the open position. For instance, when the proximity sensor (not illustrated) detects an object in proximity, the control device 30 may control the shutter 10b to move to the open position if the automated guided vehicle 20 is being called, or may control the shutter 10b to remain in the closed position if the automated guided vehicle 20 is not being called.

Once the shutter 10b is open, the automated guided vehicle 20 moves inside. When the entire automated guided vehicle 20 has moved inside the housing 10a, the control device may control the shutter 10b to move to the closed position.

The roll retrieving step (Step S31) is the step of retrieving the roll R, on which the green sheet film G has been wound. The automated guided vehicle 20, once inside the ceramic green sheet molding device 10, moves to the roll retrieval position as illustrated in FIG. 14. For example, the travel controller 288 controls the travel unit 25b to travel to the roll retrieval position.

Next, the automated guided vehicle 20 having moved to the roll retrieval position raises the roll holder from the lowered position H1 to the raised position H2. Specifically, as illustrated in FIG. 15, the roll holder lifting controller 291 controls the roll lifter 221 to raise the holder main body 220 of the roll holder 22 from the lowered position H1 to the raised position H2.

Once the holder main body 220 of the roll holder 22 reaches the raised position H2, the control device 30 controls the chucking device 131 of the winding device 13 to release the roll R from chucking. Specifically, once a sensor (not illustrated) detects that the holder main body 220 has reached the raised position H2, the chuck controller 318 controls the chuck drive 131c to slide so as to widen the distance between the pair of winding shafts 131a, thus releasing the winding core T from chucking, completing the roll removal.

Next, the automated guided vehicle 20 lowers the roll holder from the raised position H2 to the lowered position H1. Specifically, the roll holder lifting controller 291 controls the roll lifter 221 to lower the holder main body 220 of the roll holder 22 from the raised position H2 to the lowered position H1.

Subsequently, the winding core setting step (Step S32) begins. In the winding core setting step (Step S32), the automated guided vehicle 20 sets the winding core. First, the automated guided vehicle 20 moves to the winding core setting position. For example, the travel controller 288 controls the automated guided vehicle 20 to deliver the winding core, and controls the travel unit 25b to travel to the winding core setting position as illustrated in FIG. 16.

Next, the automated guided vehicle 20 having moved to the winding core setting position raises the holder main body 210 of the winding core holder 21 from the lowered position h1 to the raised position h2. Specifically, as illustrated in FIG. 17, the winding core holder lifting controller 290 controls the lifter 211 to raise the holder main body 210 of the winding core holder 21 from the lowered position h1 to the raised position h2.

Next, at the timing when the holder main body 210 has reached the raised position h2, the control device 30 controls the winding device 13 to chuck the winding core T. Specifically, when a sensor (not illustrated) detects that the holder main body 210 has reached the raised position h2, the chuck controller 318 controls the chuck drive 131c to slide the pair of winding shafts 131a from the chuck releasing position to the chucking position. The pair of winding shafts 131a narrow the gap therebetween to chuck the winding core T, thus completing the winding core setting.

Subsequently, the winding core holder lifting controller 290 lowers the holder main body 210 of the winding core holder 21 from the raised position h2 to the lowered position h1. Specifically, as illustrated in FIG. 17, the winding core holder lifting controller 290 controls the lifter 211 to lower the holder main body 210 of the winding core holder 21 from the raised position h2 to the lowered position h1.

In the roll delivering step (Step S33), the automated guided vehicle 20 moves to a warehouse (not illustrated) or the next step while delivering the roll. The control device 30 controls the shutter 10b to move to the open position. Next, the automated guided vehicle 20 travels along a predetermined route to the warehouse (not illustrated) or the next step, performing the predetermined delivery operations. When the entire automated guided vehicle 20 has exited the housing, the control device controls the shutter 10b to move to the closed position.

As configured, the automated guided vehicle 20 defining and functioning as a winding core holding device can achieve the following advantageous effects.

In order to prevent issues when the winding core holder holds a winding core with an adhesive surface, a protective film is applied to the adhesive surface of the winding core, and the winding core holder holds the winding core covered with this protective film. In this case, the protective film needs to be removed after the winding core is mounted in the chucking device of the sheet winding device. However, according to example embodiments of the present invention, such a procedure becomes unnecessary.

In order to prevent issues when the winding core holder holds a winding core with an adhesive surface, the winding core holder holds the winding core without an adhesive applied to the surface. In this case, double-sided tape needs to be applied to the winding core after the winding core is mounted in the chucking unit of the sheet winding device. However, according to example embodiments of the present invention, such a procedure becomes unnecessary.

Thus, according to example embodiments of the present invention, no additional procedures are needed after the winding core is mounted in the chucking device of the sheet winding device, preventing issues due to overlooked tasks. Even if the entire surface of the winding core is coated with an adhesive, the winding core can be properly held by the winding core holder.

Furthermore, according to example embodiments of the present invention, even if there is a misalignment in the winding core axial direction between the chucking device of the sheet winding device and the winding core, the winding core can still move in the winding core axial direction, and the adhesive force between the adhesive on the winding core surface and the roller is low, enabling the chucking device to smoothly chuck the winding core. For instance, this can help prevent the adhesive from peeling off the winding core during the chucking operation.

The automated guided vehicle 20 defining and functioning as a winding core holding device according to the present example embodiment includes the winding core holder 21 that holds the winding core T with an adhesive surface. The winding core holder 21 includes the holder main body 210, the lifter 211 that raises and lowers the holder main body 210, and the roller 212 (roller 212) held rotatably relative to the holder main body 210 to allow the winding core T to be placed movably in the winding core axial direction. The surface 212a of the roller 212 includes a high-release surface that is higher in a release property than the surface 210a of the holder main body 210.

This enables prevention of the adhesive from peeling off the winding core T, such as when the winding core T is supplied to the winding device 13.

In the present example embodiment of the automated guided vehicle 20, the holder main body 210 includes the two surfaces 210a (faces 210a) that face the winding core T when the winding core T is placed on the roller 212.

This ensures that the winding core T is properly held in the winding core holder 21.

In the present example embodiment of the automated guided vehicle 20, the two surfaces 210a are inclined so as to diverge upwards.

This ensures that the winding core T is properly held in the winding core holder 21.

In the present example embodiment of the automated guided vehicle 20, the winding core holder 21 includes at least four rollers 212.

This ensures that the winding core T is stably held while minimizing peeling the adhesive off the winding core T, such as when the winding core T is supplied to the winding device 13.

In the present example embodiment of the automated guided vehicle 20, the winding core holder 21 includes at least two rollers 212 in each of the two surfaces 210a.

This allows for more stably holding the winding core T, while preventing the adhesive from peeling off the winding core T, such as when the winding core T is supplied to the winding device 13.

In the present example embodiment of the automated guided vehicle 20, the roller includes the rollers 212.

This enables the winding core T to be stably held and moved in the winding core axial direction, while preventing the adhesive from peeling off the winding core T, such as when the winding core T is supplied to the winding device 13.

In the present example embodiment of the automated guided vehicle 20, the lifter 211 can move to raise and lower the holder main body 210 between the raised position h2 and the lowered position h1. The automated guided vehicle 20 further includes the stopper 213 that restricts the winding core T set on the roller 212 from moving in the winding core axial direction when the holder main body 210 is in the lowered position h1, and exposes the ends of the winding core T set on the roller 212 when the holder main body 210 is in the raised position h2.

This enables for chucking the winding core T when the holder main body 210 is in the raised position h2, while preventing the winding core T from slipping out of the winding core holder 21 in the winding core axial direction when the holder main body 210 is in the lowered position h1.

In the present example embodiment of the automated guided vehicle 20, the surface 212a of the roller 212, at least where the winding core T is provided, is made from a material including fluorine resin.

This helps appropriately prevent the adhesive from peeling off the winding core T, such as when the winding core T is supplied to the winding device 13.

In the present example embodiment of the automated guided vehicle 20, the roller 212 is made from fluorine resin.

This helps appropriately prevent the adhesive from peeling off the winding core T, such as when the winding core T is supplied to the winding device 13.

In the present example embodiment of the automated guided vehicle 20, electroless nickel plating including fluorine resin is provided on the surface 212a of the rollers 212, on which the winding core T is placed.

This helps appropriately prevent the adhesive from peeling off the winding core T, such as when the winding core T is supplied to the winding device 13.

In the present example embodiment of the automated guided vehicle 20, the surface 212a of the rollers 212, on which the winding core T is provided, is coated with fluorine resin.

This helps appropriately prevent the adhesive from peeling off the winding core T, such as when the winding core T is supplied to the winding device 13.

The automated guided vehicle 20 according to the present example embodiment includes the winding core holder 21 that holds the winding core T with an adhesive surface. The winding core holder 21 includes the holder main body 210, the lifter 211 that raises and lowers the holder main body 210, and the roller 212 held rotatably relative to the holder main body 210 to allow the winding core T to be movably provided in the winding core axial direction. The surface 212a of the roller 212 includes a high-release surface that is higher in a release property than the surface 210a of the holder main body 210.

This helps appropriately prevent the adhesive from peeling off the winding core T, such as when the winding core T is supplied to the winding device 13.

The controllers for normal operations of the manufacturing system S including the automated guided vehicle 20 defining and functioning as a winding core holding device is not limited to the example embodiments described above. The control functions may be distributed between the automated guided vehicle control device 27 and the control device 30, or partially or entirely hosted on a server or other devices on a network, for example. Even when the controllers are distributed, if they are functionally cooperating with the functions of the automated guided vehicle 20, they can essentially be considered as the controller 280 of the automated guided vehicle 20.

While the present example embodiment describes the automated guided vehicle as an example of the winding core holding device, the winding core holding device is not limited to automated guided vehicles. The winding core holding device is applicable to various devices including a winding core holder that holds a winding core T.

The present invention is not restricted to the configurations described in the example embodiments above and can be modified and applied within the scope that does not alter the present invention. Combinations of two or more desirable configurations described in the example embodiments are also considered as the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A winding core holding device, comprising:
a winding core holder to hold a winding core including an adhesive surface; wherein
the winding core holder includes a holder main body, a lifter to raise and lower the holder main body, and a roller movably held relative to the holder main body to enable the winding core to be placed and moved in a winding core axial direction; and
the roller includes a high-release surface that is higher in a release property than a surface of the holder main body.

2. The winding core holding device according to claim 1, wherein the holder main body includes two surfaces that face the winding core when the winding core is placed on the roller.

3. The winding core holding device according to claim 2, wherein the two surfaces are inclined so as to diverge upwards.

4. The winding core holding device according to claim 1, wherein the winding core holder includes at least four of the roller.

5. The winding core holding device according to claim 2, wherein each of the two surfaces of the winding core holder includes at least two of the roller.

6. The winding core holding device according to claim 1, wherein the roller includes a plurality of rollers.

7. The winding core holding device according to claim 1, wherein
the lifter is movable so as to raise and lower the holder main body between a raised position and a lowered position; and
the winding core holding device further includes a movement restrictor to restrict the winding core placed on the roller from moving in the winding core axial direction when the holder main body is in the lowered position, and to expose an end of the winding core placed on the roller when the holder main body is in the raised position.

8. The winding core holding device according to claim 1, wherein at least the surface of the roller, on which the winding core is placed, is made from a material including fluorine resin.

9. The winding core holding device according to claim 8, wherein the roller is made of fluorine resin.

10. The winding core holding device according to claim 8, wherein electroless nickel plating including fluorine resin is provided on the surface of the roller on which the winding core is placed.

11. The winding core holding device according to claim 8, wherein a fluorine resin coating is provided on the surface of the roller on which the winding core is placed.

12. An automated guided vehicle, comprising:
a winding core holder to hold a winding core including an adhesive surface; wherein
the winding core holder includes a holder main body, a lifter to raise and lower the holder main body, and a roller movably held relative to the holder main body to enable the winding core to be placed and moved in a winding core axial direction; and
the roller includes a high-release surface that is higher in a release property than a surface of the holder main body.

13. The automated guided vehicle according to claim 12, wherein the holder main body includes two surfaces that face the winding core when the winding core is placed on the roller.

14. The automated guided vehicle according to claim 13, wherein the two surfaces are inclined so as to diverge upwards.

15. The automated guided vehicle according to claim 12, wherein the winding core holder includes at least four of the roller.

16. The automated guided vehicle according to claim 13, wherein each of the two surfaces of the winding core holder includes at least two of the roller.

17. The automated guided vehicle according to claim 12, wherein the roller includes a plurality of rollers.

18. The automated guided vehicle according to claim 12, wherein
the lifter is movable so as to raise and lower the holder main body between a raised position and a lowered position; and
the winding core holding device further includes a movement restrictor to restrict the winding core placed on the roller from moving in the winding core axial direction when the holder main body is in the lowered position, and to expose an end of the winding core placed on the roller when the holder main body is in the raised position.

19. The automated guided vehicle according to claim 12, wherein at least the surface of the roller on which the winding core is placed is made from a material including fluorine resin.

20. The automated guided vehicle according to claim 19, wherein the roller is made of fluorine resin.
